(19) United States
(12) Patent Application Publication
(10) Pub. No.: US 2004/0055345 A1
(43) Pub. Date: Mar. 25, 2004

(54) Door lock system for trailers and cargo containers

(76) Inventor: Gregory B. Moore, Buchanan, TN (US)

Correspondence Address: Richard A. Ryan, RYAN & ENGNATH, Suite 104, 8469 N. Millbrook, Fresno, CA, 93720, US

(21) Appl. No.: 10/671,187

(22) Filed: Sep. 24, 2003

Related U.S. Application Data
(60) Provisional application No. 60/413,503, filed on Sep. 24, 2002.

(51) Int. Cl. B60R 25/04; E05B 65/12; E05B 47/00

(52) U.S. Cl. 70/257; 70/282

(57) ABSTRACT

The door lock system for trailers and cargo containers comprises a linear actuator releasably mounted on a back plate member to slidably engage a sliding bolt with a receptor on a tubular frame member of the trailer or cargo container to prevent the opening of the trailer or cargo container doors. A controller unit has an integrated circuit configured to control the operation of the linear actuator and report the status of the door to a central location. A position switch is used to indicate whether the door is open or closed so that the controller unit can automatically engage the locking mechanism to lock the door as soon as it is closed. A keypad allows a user to enter a code to unlock the door. A radio in the controller unit permits wireless communication to report status and to allow central command control over the doors.

### CROSS-REFERENCE TO RELATED APPLICATIONS

This application claims the benefit of U.S. Provisional Application No. 60/413,503 filed Sep. 24, 2002.

### BACKGROUND OF THE INVENTION

A. Field of the Invention

The field of the present invention relates generally to devices for securing the doors of a trailer or cargo container so as to prevent unauthorized entry into the trailer or container. More specifically, this invention relates to trailer and container door locking devices utilizing a computer-controlled linear actuator to secure the doors and provide for coded entry therein. Even more specifically, this invention relates to such locking devices that provide for remote operation and reporting via wireless transmission.

B. Background

Many persons utilize trailers and cargo containers for various applications, including trailers and containers that are used to transport goods, vehicles, and other materials. Although the trailers and containers commonly used in the trucking and cargo industry are very expensive, the goods being transported therein, such as electronics or cars, can often far exceed the value of the trailer or container itself. While pulling a trailer or cargo container carrier, the truck driver often needs to leave the trailer or container unmanned at a specified location. In fact, cargo containers are often utilized as storage containers that are left at the same location for extended periods of time. All too often, unfortunately, thieves utilize the opportunity of a trailer or cargo container left alone, particularly if it is at a remote location, to steal the contents of the trailer or container. Once the thieves open the trailer or container doors, they will quickly remove its contents and leave the area. Due to the nature of the crime and the goods stored therein, it is often difficult for the owner of the goods to regain possession of his or her property.

In addition to carrying or storing general consumer goods, trailers and cargo containers are utilized all over the world to carry and/or store materials that are known to be desirable to terrorists, both domestic and foreign, and other individuals or groups that desire to harm others or acquire their property. These materials include explosive devices, chemicals, weapons, ammunition, parts for repairing weapons and materials for making or using explosives and weapons. Although some of this material is transported or stored under guarded conditions, much of it is not. Because of greater concern for national security and safety throughout the world, numerous governments, military, private companies and individuals are taking a more active role in addressing or regulating the security of trailers and cargo containers. Even trailers or containers carrying or storing items once thought to be relatively benign, such as those transporting or storing food goods, are now facing increased security concerns and regulations due to the realization that such items can be easily and effectively contaminated with chemical or biological matter than could harm large numbers of people.

In light of the increased security risks and governmental oversight, unauthorized entry into and theft from trailers is a major concern among those in the trucking and cargo container industry. As security devices become more complicated and more expensive, thieves become more sophisticated and more resourceful, making protection of an unmanned trailer or container very difficult and expensive. Devices have been developed that, when regularly and properly used, generally deter the would be thief from stealing a vehicle, such as an automobile or truck, in part because of the amount of time and effort it takes to remove or get around the theft deterrent device. An example of devices that have been generally successful at reducing theft of vehicles are the various steering wheel lock devices that provide a bar across the steering wheel, making movement of the steering wheel, and hence the vehicle, virtually impossible. While the steering wheel lock devices have worked well for, there exists a need for a device that prevents entry into a trailer or cargo container in order to protect the owner's investment in the goods stored therein and to prevent sensitive materials falling into the possession of dangerous individuals or groups.

To prevent the theft of materials from inside a trailer or cargo container left or stored at protected or unprotected locations, trailer and container owners typically use exterior mechanical locking devices, such as padlocks and the like, and seals that are designed to physically prevent entry into the trailer or container. As those in the trucking industry know, experience has proven that the devices currently in use can be overcome relatively easily by the determined and resourceful thief, particularly one with a good set of bolt cutters. In addition to being relatively easy to overcome, the devices are useless if the truck driver or container operator (i.e., a person having authority to open the container to remove the contents or conduct an inventory check) forgets to set the locks. Even when the driver or operator does set the lock or locks, problems can arise if the next authorized driver or operator does not have the correct key or combination and is forced to break the lock to gain entry into the trailer or container, thereby rendering the security system useless. In areas where a number of people may need access to the contents of a trailer or container, the ability to ensure that the right person has the necessary key or combination to gain entry into the trailer or container can be quite challenging.

In order to be able to find a stolen truck and hopefully find the goods or materials carried therein, some trucking companies utilize satellite tracking devices attached to the truck and/or trailer that enable the trucking company or law enforcement personnel to track the movement of the truck/trailer. Although the theft of cargo containers is relatively less common, it is possible to load them onto a truck or other vehicle. As such, some satellite systems are also configured to work with cargo containers. Unfortunately, most satellite systems are very expensive and can be relatively easily disabled (i.e., with a screwdriver and hammer) due to the vulnerability of the antenna assembly.

Although the various theft deterrent devices currently available have some ability to prevent theft of materials from inside a trailer or cargo container, they have disadvantages and limitations that prevent wide acceptance or effective theft deterrence. One of the most common problems with presently available trailer or container security devices is the need to rely on human operation to set or re-set the security device. What is needed, is an easy to use and effective theft deterrent or locking device that allows a trailer or container owner to quickly and securely lock the trailer or container door in order to prevent unauthorized entry into the trailer or container. The preferred locking device will automatically secure the door, without the need for the human element to set the lock, and maintain the door in a locked condition until such time as an authorized individual opens the door. The preferred device will facilitate wireless communication for reporting on the door status (i.e., locked/unlocked or open/closed) and remote operation of the locking mechanism.

### SUMMARY OF THE INVENTION

The door lock for trailers and cargo containers of the present invention solves the problems identified above. That is to say, the present invention discloses a new and useful locking device that effectively prevents unauthorized entry through a trailer or container door. The door lock device of the present invention is adaptable to new and existing trailers and containers, is easy for the truck driver or container operator to engage and is difficult for the thief to overcome or disable. The door lock of the present invention automatically engages the locking system when the door is closed and maintains the lock in the locked condition until an authorized person enters the proper unlock code.

In one aspect of the door lock for trailers and cargo containers of the present invention, the door lock system comprises an electronic keypad on the exterior of the trailer or cargo container, a computerized controller unit in communication with the keypad, a linear actuator controlled by the controller unit to actuate a sliding bolt or other device into engagement with and actuator receiving mechanism, a position switch to indicate and transmit the open or closed position of the door, an antenna connected to radio in the controller unit and various connecting wiring. In one embodiment, a source of electric power, such as a battery suitable for recharging by the trailer electrical system, powers the controller unit and actuator. In the preferred embodiment, the controller unit and linear actuator are attached to back plate member that is mounted on the inside of the trailer or container door. The actuator receiving mechanism, which can be a hole located in a frame member, such as the header, is positioned and configured to receive the stainless steel bolt portion of the actuator mechanism. The position switch, which can be a reed switch having a pair of interacting magnets, one on the door frame and one on the locking mechanism or door, is used to indicate to the controller unit whether the door is in an open or closed position. If the position switch indicates an open door, the controller unit does not send a signal to the actuator to lock the door. The controller unit is configured to automatically lock the door, after a pre-set amount of time, upon receiving a signal from the position switch that the door is closed. Because the controller unit is configured to automatically activate the linear actuator after a preset elapsed time, it will relock the door even if the driver or operator forgets to set the lock. The door can be unlocked by entering the correct code on the keypad or by receiving a predetermined signal via wireless interface. The door lock system of the present invention allows the person exercising control over the contents of the trailer or container to prevent anyone, including the driver or other persons, from opening the door by limiting access to the code. The controller unit can also be configured to receive code changes, by utilizing appropriate security level clearances, that would modify the existing code to unlock the system if it were necessary because the code had been compromised or if the trailer was being sent to a different receiving party than was originally intended (as a result, requiring a different code for the new receiving party).

Accordingly, the primary objective of the present invention is to provide a door lock for trailers and cargo containers that provides the advantages described herein and overcomes the disadvantages and/or limitations associated with presently available door lock devices and systems.

It is also an important objective of the present invention to provide an easy to use and effective theft deterrent system that is difficult to overcome so as to prevent theft of materials from inside a trailer or cargo container.

It is also an important objective of the present invention to provide a door lock for trailers and cargo containers that utilizes a computer-controlled actuator to drive a sliding bolt into a frame member or receiver mounted to the frame of a trailer or cargo container when the door is closed or upon command by a user received through a keypad entry or over a wireless network.

It is also an important objective of the present invention to provide a door lock for trailers and cargo containers that is adaptable for new and retrofit installations at various locations on the doors of the trailer or cargo container.

It is also an important objective of the present invention to provide a door lock device for trailers and cargo containers that can interact with other locking systems to automatically lock the doors and maintain the doors in a locked condition until such time as the proper code is entered into the door lock system.

It is also an important objective of the present invention to provide a door lock for trailers and cargo containers that is useful for both trailers and cargo containers with or without their own source of power and for the swing and roll-up types of doors.

The above and other objectives of the present invention are explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the best modes presently contemplated for carrying out the present invention:

FIG. 1 is a front view of the door locking component of the door lock system of the present invention from inside a trailer or cargo container with the swing doors closed;

FIG. 2 is a side view of a preferred embodiment of the door locking system of the present invention;

FIG. 3 is a front view of the actuator mechanism and its related components mounted on the back plate member;

FIG. 4 is a front view of the actuator mechanism, controller unit and position switches of the door lock system of the present invention;

FIG. 5 is a front view of a keypad configured to operate with the door lock system of the present invention;

FIG. 6 is a isometric view of the front end of a trailer showing the placement of he keypad thereon;

FIG. 7 is a front view of a keypad having a visual representation of the locked and unlocked doors;

FIG. 8 is a front view of a keypad configured to be separate from the trailer and engageable with the door lock system when used to operate the controller unit; and

FIG. 9 is a front view of the door locking component of the door lock system configured for use with a roll-up door from inside a trailer or cargo container having the roll-up door closed.

### DETAILED DESCRIPTION OF THE PREFERRED EMBODIMENTS

With reference to the figures where like elements have been given like numerical designations to facilitate the reader's understanding of the present invention, and particularly with reference to the embodiments of the present invention illustrated in the figures, the preferred embodiments of the present invention are set forth below. The enclosed figures and drawings are merely illustrative of the preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

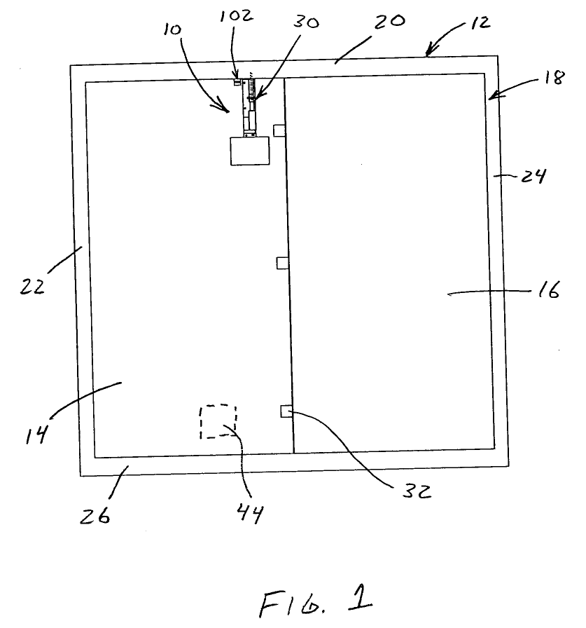

A preferred embodiment of the door lock system for trailers and cargo containers of the present invention, identified generally as 10 in the figures is configured to function with trailers or cargo containers, or other enclosed body, shown generally as 12 in FIG. 1 (hereinafter trailers, cargo containers and other enclosed bodies are collectively referred to as trailers). Such trailers 12 are commonly utilized in the trucking and storage industries to move and store numerous types of materials, including consumer goods and sensitive or dangerous materials. There are many different types of trailers 12 in use, many of which are configured to meet or exceed International Standards Organization (ISO) trailer/container requirements or other regulations pertaining to domestic trailer and/or cargo container configurations. In one configuration, trailers 12 have a pair of swing-type loading doors 14 and 16 mounted on a structural frame 18 having a plurality of frame members, including top member or header 20 supported by side members 22 and 24 above bottom member or threshold 26. As shown in FIG. 9, trailer or cargo container 12 can be configured with a single roll-up door 28 that is rolled or slid upward at the rearward opening of trailer 12. As shown in FIG. 1, which shows the view from inside trailer 12 with doors 14 and 16 closed, the door locking component 30 of door lock system 10 can be mounted on door 14 near header 20 to operatively engage header 20. Alternatively, door locking component 30 can be mounted on door 14 at or near threshold 26 to operatively engage threshold 26. In either configuration, door locking component 30 should be mounted generally near the center of header 20 or threshold 26 where doors 14 and 16 meet, as shown in FIG. 1. As shown, after door 16 is closed, door 14 closes to abut against the overlap plates 32 on door 16. As shown in FIG. 9, door locking component has a different configuration to prevent unauthorized entry into trailer 12 having roll-up door 28. In either configuration, as explained in more detail below, door lock system 10 is utilized with trailer 12 to prevent unauthorized entry into the interior storage compartment of trailer 12 through doors 14 and 16 or roll-up door 28.

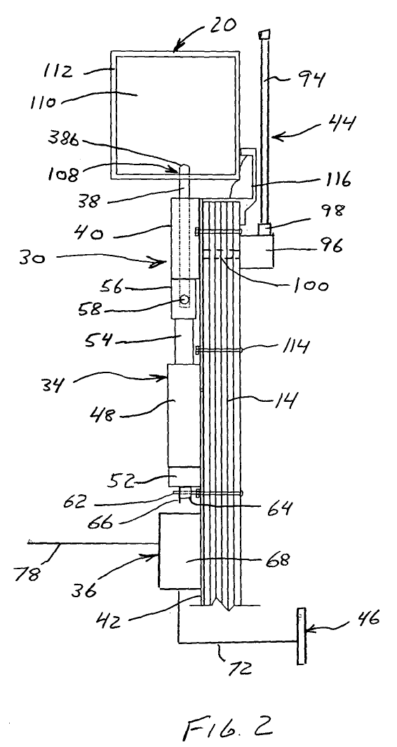

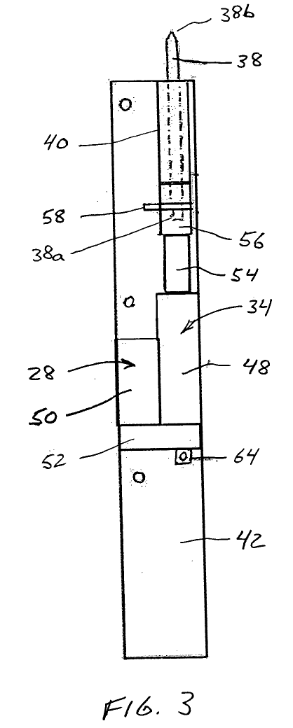

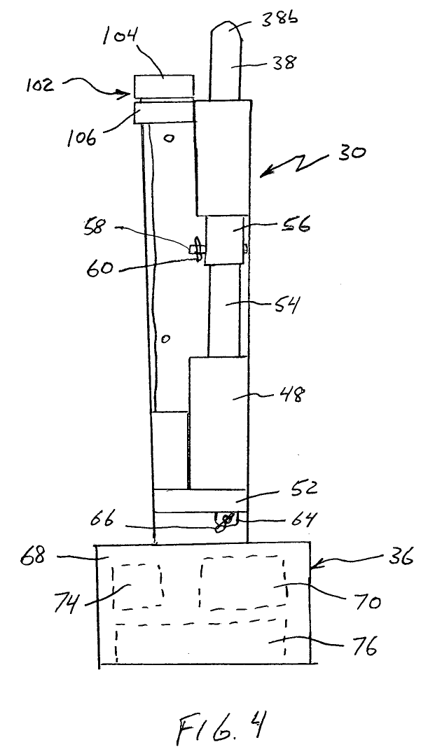

In a preferred embodiment of the door lock system 10 of the present invention, door locking component 30 primarily comprises an actuator mechanism 34 controlled by computerized controller unit 36 to drive sliding bolt 38 slidably disposed in tubular member 40, all of which are mounted on or attached to back plate member 42, as shown in FIG. 2. As set forth in more detail below, in the preferred embodiment of the door lock system 10, controller unit 36 is operatively connected to antenna system 44. A keypad 46 is utilized for accessing controller unit 36 to engage or disengage door lock system 10, as shown generally in FIG. 2. In the preferred embodiment, actuator mechanism 34 is a electro-mechanical linear actuator having a main body 48 with a drive screw or other drive mechanism inside, a motor 50 to drive the drive mechanism and a gear box 52, as shown in FIGS. 2 and 3. Although other actuating systems can be used, including hydraulic, pneumatic or solenoid-based actuating systems, these systems have certain well known operational and functional disadvantages that make the electro-mechanical type of actuator mechanism 34 the preferred actuator. The drive mechanism inside main body 48 actuates actuating rod 54, which is coupled to sliding bolt 38 at collar 56 by first pin 58. In the preferred embodiment, collar 56 is welded or otherwise joined to first end 38a of sliding bolt 38. First pin 58 is placed through holes in sliding bolt 38, actuating rod 54 and collar 56 to couple these components together such that the actuation of actuating rod 54 by actuator mechanism 34 will cause sliding bolt 38 to move inside tubular member 40 along its longitudinal axis. In the preferred embodiment, first pin 58 is the type that cooperates with first spring clip 60, best shown in FIG. 4, to releasably maintain first pin 58 engaged with actuating rod 54, sliding bolt 38 and collar 54. Second pin 62, which in the preferred embodiment projects outwardly from a fixed position on back plate member 42, engages a hole in base extension 64 to hold actuator mechanism 34 in place on back plate member 42, as best shown in FIGS. 2 and 3. In the preferred embodiment, second spring clip 66, best shown in FIG. 2, is utilized to releasably maintain the coupling of second pin 62 with base extension 64.

As is known in the art, the typical linear actuator 34 has an actuating rod 54 that is threaded inside main body 48 to permit linear adjustment of the distance which actuating rod 54 extends. Use of first pin 58 prevents undesirable rotation of actuating rod 54, which could cause actuating rod 54 to become unthreaded inside main body 48. Use of spring clip 60 with first pin 58 allows a person who is inadvertently closed inside the locked trailer 12 to remove first pin 58 and, as explained more fully below, uncouple actuator mechanism 34 from the other components so the doors 14 and 16 can be opened. Use of second pin 62 further facilitates the removal of actuator mechanism 34 from back plate member 42 in case of a person stuck inside trailer 12. In the embodiment shown in the drawings, a person inside locked trailer 12 would first remove second spring clip 66 from second pin 62 and pull actuator mechanism 34 at extension 64 away from back plate member 42 and off of second pin 62. The person then could remove first spring clip 60 from first pin 58 and uncouple first pin 58 from actuating rod 54, sliding bolt 38 and collar 56. Actuator mechanism 34 could then be lowered to remove second end 38b of sliding bolt 38 from engagement with header 20 (as explained below). To facilitate this operation, first spring clip 60 and second spring clip 66 can be of the quick-release type commonly utilized in various connecting operations.

As best shown in FIGS. 2 and 4, in the preferred embodiment of door lock system 10 of the present invention, controller unit 36 is mounted to the front side of back plate member 42. Controller unit 36 has a housing 68 that encloses appropriate computer circuitry and componentry, shown as integrated circuit board 70 on FIG. 4, for controller unit 36 to read and analyze incoming signals from various components of door lock system 10 so as to operate actuator mechanism 34 to lock or unlock door lock system 10. Preferably, housing 68 sealably encloses the components inside controller unit 36 to prevent intrusion of water or other fluids that could damage the computer circuitry and componentry 70 (i.e., integrated circuit) and other components therein. Controller unit 36 is in communication with keypad 46 such that operation of keypad 46 can control the locking and unlocking by door locking component 30. In the embodiment shown in the figures, keypad 46 connects to controller unit 36 by keypad wire 72. Other known mechanisms of connecting keypad 46 to controller unit 36 can be utilized. In the preferred embodiment, controller unit 36 also encloses a radio or other communication device, shown as 74 in FIG. 4, to permit wireless radio communication with a remote central office (i.e., via a cellular communications network or satellite connection) or even to a hand-held radio device placed near trailer 12. In one embodiment, the communication device 74 is a 900 MHz, 32 bit encryption radio. The preferred embodiment of the present invention 10 for use with trailers, as opposed to cargo containers, also has a rechargeable battery 76 located inside controller unit 36, preferably in a sealed compartment so it cannot damage the other components, and operatively connected to the electrical system of trailer 12, by battery wire 78 in FIG. 2, to allow recharging of battery 76 by the electrical system of trailer 12 or the vehicle pulling trailer 12. As shown in FIGS. 1 and 4, housing 68 will generally need to be somewhat larger size to accommodate battery 76 therein. Without battery 76, controller unit 36 is typically the same width as back plate member 42. The use of battery 76 will generally not be preferred when door lock system 10 is used with cargo containers or like containers due to the lack of electrical system or other mechanism for recharging battery 76. In some situations, it may be possible to utilize solar panels or similar devices to create a recharging system to allow use of battery 76 in door lock system 10 when used with cargo containers and the like.

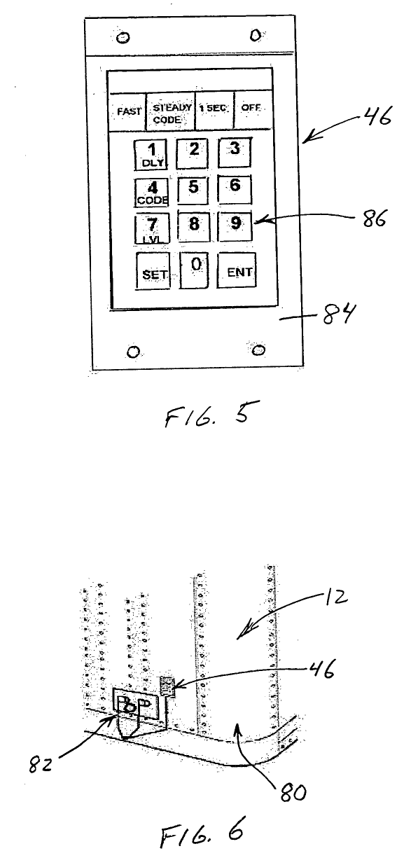

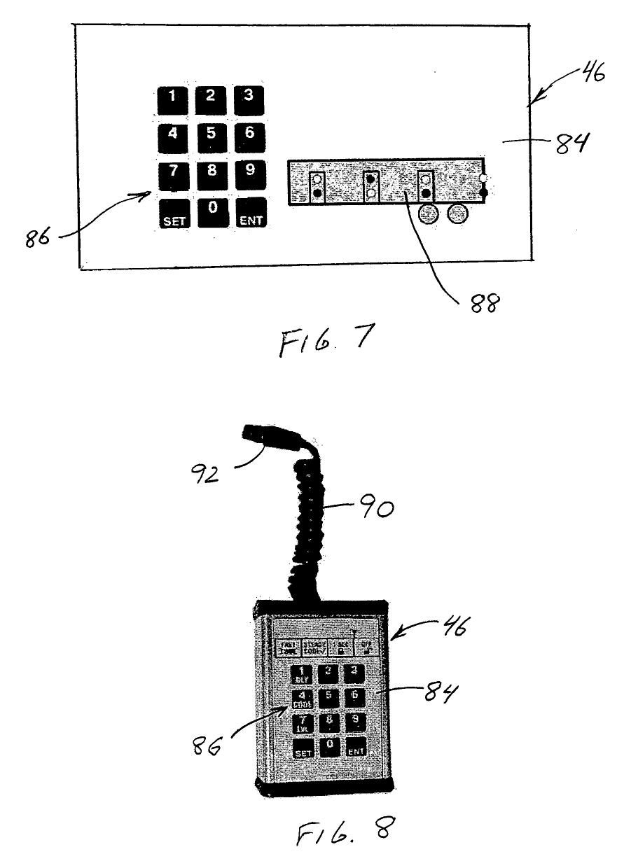

On the exterior of trailer 12 is placed electronic keypad 46, which is shown in detail in FIG. 5, to allow authorized persons to lock or unlock door lock system 10 to open doors 14 and 16. As stated above, keypad can connect to controller unit 36 via keypad wire 72 and be located on door 14, as shown in FIG. 1, or other places at the rear of trailer 12. Alternatively, keypad 46 can be placed at the front end 80 of trailer 12, as shown in FIG. 6. This location may be particularly beneficial if door lock system 10 is used in conjunction with a brake lock system 82 for preventing unauthorized movement of trailer 12. Keypad 46 comprises a keypad case 84 having a plurality of function keys 86, such as the numeric and command keys shown in FIG. 5, sufficient for secure operation of controller unit 36. In the preferred embodiment, keypad 46 is securely mounted to trailer 12 to prevent keypad 46 falling off during transit or being easily removed by unauthorized persons. If desired, keypad 46 can be configured with a visual representation 88 of the locked/unlocked status of the various doors on trailer 12, as shown in FIG. 7. Different colored lights can be utilized to signal locked and unlocked conditions of the various doors. This could be particularly important when trailer 12 is utilized to transport different types (i.e., frozen, refrigerated and dry goods) of food materials. Once loaded into different compartments that are securely separated inside trailer 12, governmental regulations prohibit more than one door being open at any given time to avoid contamination of the food materials. Failure to abide by these regulations can result in significant fines and the intended recipient refusing to take the food materials. The keypad 46 of FIG. 7 lets the user know at a glance which, if any, doors are unlocked. If placed at front end 80 of trailer 12, the keypad 46 of FIG. 7 can be seen in the driver's rearview mirror while trailer 12 is in transit.

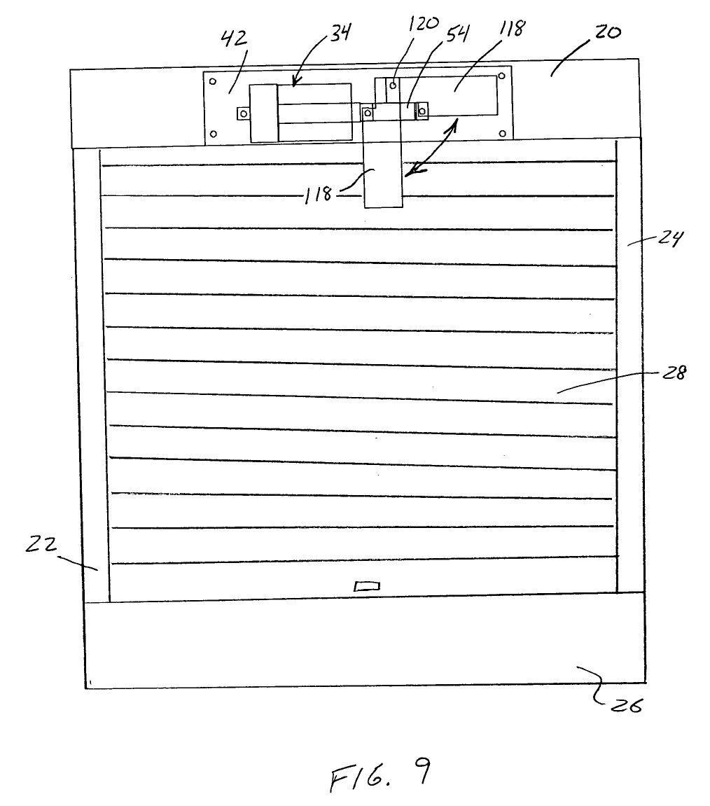

In another embodiment of keypad 46, shown in FIG. 8, the keypad 46 can be a portable device that has cord 90 with connector 92 at the end thereof that is adapted to connect to a like-configured port (not shown) on trailer 12. In another configuration, keypad case 84 can enclose a battery (not shown) to operate actuator mechanism 34. This embodiment is particularly useful when door lock system 10 is utilized with a cargo container that does not have its own electrical system or is not connected to another electrical system so as to recharge battery 76 inside controller unit 36. In yet another embodiment, keypad 46 can include a separate computer componentry to allow it to store and analyze data and a display panel to display that information. For instance, such a keypad 46 can be utilized for inventory purposes. Every time someone opens doors 14 and 16 to add material in trailer 12 or remove material from trailer 12, he or she can enter the amount of material (i.e., ammunition or explosive devices) being removed from trailer 12. In this manner, the inventory of material inside trailer 12 will be known, particularly to persons remote from trailer 12, which can be accomplished by transmitting such information via a wireless network.

Antenna system 44, shown in FIG. 2, is used to improve the reception for radio 74 located inside housing 68 of controller unit 36 so that door lock system 10 can be controlled or monitored remotely (i.e., at company headquarters, etc.). In the embodiment shown in FIG. 2, antenna system 44 comprises antenna rod 94 mounted on mounting box 96 by antenna adapter 98. The components for antenna system 44 should be selected to operatively correspond to radio 74. For instance, if radio 74 is a 900 MHz radio, then antenna system 44 should be a 900 MHz antenna so as to provide optimum performance for radio 74. To utilize antenna system 44, a hole 100 should be drilled or otherwise provided in door 14 to allow an antenna wire (not shown) to pass from antenna rod 94 to radio 74 in controller unit 36. Antenna system 44 can be of the type that communicates with a GPS tracking unit located in the cab of a truck utilized to haul trailer 12. Instead of utilizing antenna rod 94 and the other external components, antenna system 44 can be configured to be internal to keypad 46 and included in the keypad wire 72 that connects to controller unit 36. In one configuration, antenna system 44 is a loop antenna disposed inside keypad 46 or, if signal strength is or will not be a problem, inside controller unit 36 itself.

The preferred embodiment of door lock system 10 of the present invention further comprises a position switch 102, as shown in FIGS. 1 and 4, in communication with the computer circuitry 70 in controller unit 36 to indicate the open or closed position of door 14. A variety of position switches 102 may be employed for communicating the position of door 14 to the integrated circuit 70 of controller unit 36. As explained in more detail below, door lock system 10 of the present invention utilizes information pertaining to the position of door 14 to operate actuator mechanism 34 so as to operatively engage sliding bolt 38 with header 20. In the preferred embodiment, position switch 102 is a reed switch having a first magnet 104 mounted to frame 18, such as to header 20 or threshold 26 as the case may be, and a second magnet 106 mounted to door locking component 30, such as on back plate member 42, so as to swing open and close with door locking component 30 as door 14 is opened or closed. As is well known in the art, a magnetic field between magnets 104 and 106 is employed to open and close connections to leads of integrated circuit 70. Other types of proximity types of switches can be used to determine the opened or closed position of door 14 to open or close a connection to integrated circuit 70, including various traditional contact mechanisms, so as to cause controller unit 36 to operate actuator mechanism 34. Although it is preferred that position switch 102 be located on or near door locking component 30, position switch 102 could be located away from door locking component 30 (i.e., at threshold 26 if door locking component 30 at header 20, or vice-versa).

In the preferred embodiment, back plate member 42 is made out of steel or other durable and strong material. Tubular member 40 can made from a steel tubular material and machine welded or otherwise fixed to back plate member 42. Second pin 62 can extend from the back side of back plate member 42 through back plate member 42 to extend frontwardly, as shown if the figures. Housing 68 for controller unit 36 can be bolted, welded or otherwise attached to back plate member 42. As stated above, main body 48 of actuator mechanism 34, actuating rod 54, collar 56 and sidling bolt 38 can be removably attached to second pin 62 and slidably received inside tubular member 40. In one configuration, sliding bolt 38 is a ¾″ stainless steel bolt and tubular member 40 has an inside diameter of ⅞″ to allow sliding bolt 38 to be slidably disposed therein and to move with out substantial interference from tubular member 40. To prevent door 14 from being opened, sliding bolt 38 is configured to engage a receptor 108 in or mounted to header 20 or threshold 26. In the preferred embodiment, as shown in FIG. 2, receptor 108 is a hole drilled or otherwise provided in header 20 that is sized and configured to slidably receive sliding bolt 38 inside chamber 110 of the tubular frame 112 of header 20, which can be a 4″ by 4″ square tubular member. In one configuration, the top of door locking component 30 is positioned approximately one inch below the bottom of header 20, by mounting back plate member 42 to door 14, and sliding bolt 38 has an actuating distance of approximately two inches, such that approximately one inch of second end 38b of sliding bolt 38 is received inside chamber 110 of tubular frame 112 of header 20 (or threshold 26). If desired, depending on the desired amount of security necessary, the amount of sliding bolt 38 received inside chamber 110 can be increased or decreased. Back plate member 42 can be mounted to door 14 using a plurality of bolts, such as carriage bolts 114, that pass through door 14 and back plate member 42. As known to those skilled in the art, a variety of other connection mechanisms and devices are also suitable for connecting back plate member 42 to door 14. Upper bracket 116, currently utilized by most trailers 12, prevents external access to sliding bolt 38.

In operation with door locking component 30, position switch 102, keypad 46 and antenna system 44 mounted in place, the locked position (as shown in FIG. 2) has second end 38b of sliding bolt 38 disposed through receptor 108 inside chamber 110 of tubular frame 112 of header 20. As such, door 14, and consequently door 16, cannot be opened. In order to open doors 14 and 16, an authorized person enters the appropriate code on keypad 46 to cause controller unit 36 to operate actuator mechanism 34 to cause actuating rod 54 to move downward. Because of the connection at collar 56, sliding bolt 38 is also moved downward such that second end 38b thereof is no longer engaged in or through receptor 108 into chamber 110. Once sliding bolt 38 is free of header 20, doors 14 and 16 may be swung open. In the preferred embodiment, integrated circuit 70 includes or is connected to a timer that will automatically operate actuator mechanism 34 after a preselected amount of time to move sliding bolt 38 upward into engagement with receptor 108 in or attached to header 20. This feature is particularly useful if someone unlocks door lock system 10 but is called away or otherwise does not open door 14 within the preset time period. To prevent sliding bolt 38 moving upward when door 14 is open, integrated circuit 70 will only move sliding bolt 38 into locking engagement if position switch 102 indicates that door 14 is closed. If position switch 102 indicates door 14 is closed and the preset time on the timer expires, then integrated circuit 70 of controller unit 36 will send a command to actuator mechanism to move sliding mechanism into engagement with receptor 108 at or in header 20. If door 14 is open, as indicated by position switch 102, when the preset time on the timer expires, integrated circuit 70 will not send a command to actuate sliding bolt 38. As soon thereafter that position switch 102 indicates to controller unit 36 that door 14 is closed, integrated circuit 70 will send the command to acuate sliding bolt 38 to engage it in receptor 108 in header 20. In this manner, controller unit 36 will automatically engage door lock system 10 to lock door 14, thereby eliminating the need for the driver or operator to remember to engage door lock system 10 after closing door 14. This will eliminate unlocked doors 14 and 16 caused by human error due to forgetting to lock doors 14 and 16. In addition to being used to automatically lock or prevent locking of door 14, position switch 102 is utilized to report the status, open or closed, of door 14 to remote locations. When used with wireless communications, door 14 can be locked or unlocked remotely.

Information pertaining to the opening and closing of door 14 can be stored inside controller unit 36 and/or sent over a wireless network to the remote location, including transmissions on a real time basis. In this manner, oversight of access to the interior of trailer 12 can be maintained, thereby reducing the likelihood of unauthorized access to the contents inside trailer 12 by “insider” persons who otherwise have the codes and authority to operate keypad 46. This should significantly reduce the likelihood of employee or related party theft of materials from trailer 12. When used with GPS and like systems (i.e., a 911 based location system), a central command center will be able to determine if a trailer 12 is where it is supposed to be and if someone is accessing the materials stored therein. Depending on the materials being transported or stored in trailer 12, immediate action can be taken to prevent the unauthorized removal or theft of the material.

The door lock system 10 of the present invention allows the person exercising control over the contents of trailer 12 to prevent anyone, including the driver, from opening door 14 by limiting access to the correct code. Keypad 46 can also be configured to receive code changes, by utilizing appropriate security level clearances, that would modify the existing code to unlock the system 10 if it were believed the security code had been compromised or if trailer 12 was being sent to a different receiving party than was originally intended (as a result, requiring a different code for the new receiving party). As discussed above, the door lock system 10 of the present invention can be configured to interact with a satellite or cellular telephone system and a GLS/GPS system such that it will transmit a signal if door 14 is opened without the proper code being entered and identify the location of trailer 12. As also shown in FIG. 6, the door lock system 10 can work with a brake lock system 82 configured to prevent unauthorized movement of trailer 12. When door lock system 10 is used In conjunction with brake lock system 82, a would be thief is prevented from moving trailer 12 from its designated location, which makes theft of materials from inside trailer 12 much more difficult on the thief when he or she cannot easily open doors 14 and 16 due to door lock system 10. As is well known, time is generally one of the primary means of discouraging a thief. If the thief is bold enough to attempt to break into trailer 12 where it sits, door lock system 10 will make this difficult and, if it happens, will transmit a signal indicating an unauthorized entry into trailer 12 to a central location or police station.

In addition to the safety feature regarding persons inadvertently locked inside of trailer 12, which can be caused by accidently closing door 14 when someone inside (i.e., wind blowing, etc.), door lock system 10 is configured to prevent a broken or missing position switch 102 from causing door 14 to be stuck in a locked condition. Integrated circuit 70 is configured such that information from position switch 102 is not required to send a command to actuator mechanism 34 to disengage sliding bolt 38 from receptor 108 to open door 14. An open command can be sent at any time from controller unit 36. As such, if position switch 102 becomes damaged during loading or unloading materials into or from trailer 12 or if it breaks during transit, the driver, operator or other authorized person can still open door 14 by entering the correct code at keypad 46. Naturally, if position switch 102 is damaged, door lock system 10 will not be able to be relocked, which prevents door 14 being placed in essentially a “stuck” locked condition.

Various modifications to the door lock system 10 are possible. For instance, instead of having second end 38b of sliding bolt 38 engage a hole in header 20 or threshold 26, a separate receptor 108 can be mounted on or attached to header 20 or threshold 26. The hole drilled into header 20 or threshold 26 is preferred because it does not interfere with the ingress and egress of materials from trailer 12 and is significantly less likely to be damaged than a separate component. If desired, depending on the environmental conditions in which trailer 12 is or will be utilized, a cover (not shown) can be placed over all or part of actuator mechanism 34 to prevent dirt, dust and other debris or fluids from contacting the covered components.

In another embodiment, shown in FIG. 9, instead of actuating sliding bolt 38 along a straight linear path into receptor 108, actuator mechanism 34 is utilized to pivot tongue 118 so as to block the roll-up path of roll-up door 28. As shown in FIG. 9, the linear movement of actuating rod 54 acts on tongue 118 so as to pivot it around pivot connector 120. Tongue 118 is shaped and configured to pivotally react when actuating rod 54 is extended outward or drawn into main body 48 of actuator mechanism 34. As shown, back plate member 42 is mounted to the inside wall of header 20 such that tongue 118 is pivoted from a down position that blocks the movement of roll-up door 28 to an up position along back plate 42 and header 20 that allows roll-up door 28 to be rolled along the tracks inside trailer 12. With tongue 118 facing downward in the down position any upward movement of roll-up door 28 is prevented, thereby keeping roll-up door 28 in a closed position. The remaining components for door lock system 10 of this embodiment can be the same as described above for swing doors 14 and 16. While there are shown and described herein certain specific alternative forms of the invention, it will be readily apparent to those skilled in the art that the invention is not so limited, but is susceptible to various modifications and rearrangements in design and materials without departing from the spirit and scope of the invention. For instance, it should be noted that the present invention is subject to modification with regard to the dimensional relationships set forth herein and modifications in assembly, materials, size, shape and use. For example, while a certain computer, electronic and radio devices and materials have been used in the embodiments of the invention set forth above, other such devices and materials could also be used. Therefore, it is contemplated that the appended claims will cover any modifications or embodiments as fall within the true scope of the invention.

What is claimed is:

1. A door lock system for a door used in a trailer, said system comprising:
a door locking apparatus comprising a back plate member, an actuator mounted on said back plate member and a locking member attached to said actuator, said back plate member configured to be mounted on an interior surface of said trailer, said locking member having a first end and a second end, said first end of said locking member configured to prevent the opening of said door when said door lock system is in a locked position, said second end of said locking member connected to an actuating rod of said actuator, said actuator configured to operatively actuate said locking member so as to selectively lock said door;
a controller unit in communication with said door locking apparatus, said controller unit having computer circuitry and componentry configured to control the operation of said door locking apparatus; and
a keypad in communication with said controller unit, said keypad configured to transmit operational instructions to said controller unit.

2. The system according to claim 1, wherein said trailer has a frame comprising a one or more tubular frame members, said first end of said locking member being configured to be slidably received in a receptor disposed in one of said one or more tubular frame members and cooperatively engaged therewith to prevent the opening of said door until an open command is received from said controller unit.

3. The system according to claim 2, wherein said locking member is configured to be slidably engaged with a header of said frame.

4. The system according to claim 2, wherein said locking member is configured to be slidably engaged with a threshold of said frame.

5. The system according to claim 2, wherein said door locking apparatus further comprises a tubular member mounted to said back plate member, said locking member is a sliding bolt slidably disposed in said tubular member and said receptor is a hole in said tubular frame member sized and configured to receive said sliding bolt.

6. The system according to claim 1, wherein said locking member is configured to operatively engage a receptor attached to a frame member of said trailer.

7. The system according to claim 1, wherein said actuating rod is releasably connected to said locking member and said actuator is releasably connected to said back plate member for selective disengagement of said actuator from said back plate member.

8. The system according to claim 1, wherein said back plate member is mounted to said door and said locking member cooperatively engages a frame member of said trailer to prevent the opening of said door.

9. The system according to claim 1, wherein said back plate member is mounted to a frame member of said trailer and said locking member cooperatively engages said door to prevent the opening of said door.

10. The system according to claim 1 further comprising a radio in communication with said controller unit.

11. The system according to claim 10, wherein said radio is configured for the transmission of signals across a wireless communication network.

12. The system according to claim 1, wherein said actuator is an electro-mechanical linear actuator.

13. The system according to claim 1, wherein said controller unit is operatively connected to a source of electrical power.

14. The system according to claim 1 further comprising a position switch in communication with said controller unit, said position switch configured to detect whether said door is in an open position or a closed position.

15. The system according to claim 14, wherein said position switch is a reed switch having a first magnet attached to said interior surface of said trailer and a second magnet attached to one of said door locking apparatus or said door.

16. A door lock system for a door used in a trailer having a frame comprising one or more tubular frame members, said system comprising:
a door locking apparatus comprising a back plate member, a linear actuator mounted on said back plate member and a locking member attached to said linear actuator, said back plate member configured to be mounted on said door, said locking member having a first end and a second end, said first end of said locking member configured to be slidably received in a receptor disposed in one of said one or more tubular frame members and cooperatively engaged therewith to prevent the opening of said door when said door lock system is in a locked position, said second end of said locking member connected to an actuating rod of said linear actuator, said linear actuator configured to operatively actuate said locking member so as to selectively lock said door;
a controller unit in communication with said door locking apparatus, said controller unit having computer circuitry and componentry configured to control the operation of said door locking apparatus;
a position switch in communication with said controller unit, said position switch configured to detect whether said door is in an open position or a closed position; and
a keypad in communication with said controller unit, said keypad configured to transmit operational instructions to said controller unit.

17. The system according to claim 16, wherein said locking member is configured to be slidably engaged with a header of said frame.

18. The system according to claim 16, wherein said locking member is configured to be slidably engaged with a threshold of said frame.

19. The system according to claim 16, wherein said door locking apparatus further comprises a tubular member mounted to said back plate member, said locking member is a sliding bolt slidably disposed in said tubular member and said receptor is a hole in said tubular frame member sized and configured to receive said sliding bolt.

20. The system according to claim 16, wherein said actuating rod is releasably connected to said locking member and said linear actuator is releasably connected to said back plate member for selective disengagement of said linear actuator from said back plate member.

21. The system according to claim 14, wherein said position switch is a reed switch having a first magnet attached to said interior surface of said trailer and a second magnet attached to one of said door locking apparatus or said door.
